(19) United States
(12) Patent Application Publication
(10) Pub. No.: US 2013/0015806 A1
(43) Pub. Date: Jan. 17, 2013

(54) Tamper-Resistant Network-Attached Energy System with Access Control

(71) Applicants: Bryan T. Silbermann, San Mateo, CA (US); Thomas J. Huber, San Francisco, CA (US)

(72) Inventors: Bryan T. Silbermann, San Mateo, CA (US); Thomas J. Huber, San Francisco, CA (US)

(73) Assignee: Lumenir, Inc., San Mateo, CA (US)

(21) Appl. No.: 13/548,609

(22) Filed: Jul. 13, 2012

Related U.S. Application Data
(60) Provisional application No. 61/507,229, filed on Jul. 13, 2011.

(51) Int. Cl. H02J 7/00

(52) U.S. Cl. 320/101; 320/107

(57) ABSTRACT

Described herein are a system and method to provide energy to consumers using a prepaid usage model so as to protect the ability to recoup start-up and recurrent costs while simultaneously offering lower-income individuals the ability to access the energy on-demand. The system and method allow verification with an account server of a user's prepaid usage balance so an energy provider need not extend credit to the user or bill a user after energy usage. The system is portable and versatile in that it can be adapted to different energy sources including renewable energy sources such as wind, water, and/or solar sources. Anti-tampering features reduce the likelihood that the energy system will be disassembled with the components appropriated for repurposing.

### CROSS-REFERENCE TO RELATED APPLICATIONS

This application claims priority to U.S. Provisional Patent Application No. 61/507,229, entitled “Network Attached Solar Energy System” and filed Jul. 13, 2011, the disclosure of which is incorporated herein by reference.

### BACKGROUND OF THE INVENTION

1. Field of the Invention

The present invention relates generally to energy systems, and particularly, to controlling access to energy systems.

2. Description of the Prior Art

Approximately 1.6 billion individuals worldwide live without electricity. Many of these individuals live a subsistence life, often on less than $2 a day. These individuals are often dependent on kerosene, batteries, and local timber. Today, Africa spends over 18 billion dollars yearly on kerosene, and the average African spends around $4 a month on kerosene. These individuals have the financial means to purchase kerosene in small amounts as they need it, but do not have credit or savings to switch to a cleaner, more convenient power source. In many of these countries, moreover, these individuals are acquiring cell phones, but do not have the means to charge them at home. As dependence on cell phones increases, charging becomes more important.

In communities where reliable electric power grids do exist, electrical energy is often consumed as a credit-based service. An energy user (who does not own the power-generating or -distributing infrastructure) pays for the amount of energy consumed, typically at regular intervals and/or at the end of a use period.

Other utility services (e:g., telecommunications) use a pay-in-advance model. A prepaid calling card is filled with a number of usage minutes depending on how much money a user has prepaid. Additional usage minutes can be prepaid as needed.

One challenge of introducing renewable energy into second- and third-world countries is that the cost of the energy is primarily a result of start-up costs (e.g., manufacture, distribution, and installation of the generation equipment and distribution infrastructure) rather than recurring costs (e.g., maintenance). These start-up costs can result in energy rates that become oppressive for individuals in poor countries--especially for more recently developed renewable energy technologies such as solar power.

What is needed is a way to provide energy to consumers using a prepaid usage model so as to protect the need to recoup start-up and recurrent costs while simultaneously offering lower-income individuals the ability to access the energy on-demand.

### SUMMARY

In one embodiment is provided a tamper-resistant, network-attached system comprising: a battery; a charger coupled to the battery, the charger configured to receive energy from an energy source and store the received energy in the battery; a cutoff switch configured to receive the stored energy across an electrical connection between the cutoff switch and the battery, the cutoff switch further configured to output the received stored energy when a communication signal is received on a signal line of the cutoff switch; an encapsulant material configured to encapsulate the electrical connection between the cutoff switch and the battery and at least a portion of the cutoff switch including the signal line of the cutoff switch; an energy conversion circuit configured to receive the stored energy output from the cutoff switch and convert the received stored energy output from the cutoff switch into a form of energy useable by utilization equipment coupled to the system; a network adapter configured to communicate across a network; a user interface; and a microprocessor configured to: provide the communication signal to the signal line of the cutoff switch; receive through the user interface an activation code for a usage balance for the system; determine that the received activation code for the usage balance is valid by communicating through the network adapter across the network with an account server; command the energy conversion circuit to deliver the converted form of energy to the utilization equipment coupled to the system; determine that the usage balance has been depleted; and command the energy conversion circuit to no longer deliver the converted form of energy to the utilization equipment coupled to the system.

In another embodiment is provided a tamper-resistant, network-attached system comprising: a battery; a charger coupled to the battery, the charger configured to receive energy from an energy source and store the received energy in the battery; a cutoff switch configured to receive the stored energy across an electrical connection between the cutoff switch and the battery, the cutoff switch further configured to output the received stored energy when a communication signal is received on a signal line of the cutoff switch; an encapsulant material configured to encapsulate the electrical connection between the cutoff switch and the battery and at least a portion of the cutoff switch including the signal line of the cutoff switch; an energy conversion circuit configured to receive the stored energy output from the cutoff switch and convert the received stored energy output from the cutoff switch into a form of energy useable by utilization equipment coupled to the system; a network adapter configured to communicate across a network; a user interface; and a microprocessor configured to: provide the communication signal to the signal line of the cutoff switch; receive through the user interface an activation code for a usage balance for the system; determine that the received activation code for the usage balance is valid by communicating through the network adapter across the network with an account server; command the charger to deliver energy from the energy source to the battery; determine that the usage balance has been depleted; and command the charger to no longer deliver energy from the energy source to the battery.

### BRIEF DESCRIPTION OF DRAWINGS

FIG. 1 is a block diagram illustrating a tamper-resistant network-attached energy system according to one embodiment.

FIG. 2 is a flow chart of a method for control of a tamper-resistant network-attached energy system according to one embodiment.

FIG. 3 is a block diagram illustrating encapsulation of components of a tamper-resistant network-attached energy system according to one embodiment.

### DETAILED DESCRIPTION OF THE INVENTION

Embodiments of a system and method described herein provide a way to gate access to an energy system so that energy can be provided to a user on a prepaid (or “pay-and-go”) basis. These embodiments allow a user to purchase credit to buy energy on-demand as needed while respecting budgetary concerns.

The system and method described herein verify with an account server a user's prepaid usage balance (“usage balance”) so an energy provider need not extend credit to the user or bill a user after energy usage. The system is portable and versatile in that it can be adapted to different energy sources including renewable energy sources such as wind, water, and/or solar sources. Anti-tampering features reduce the likelihood that the portable and versatile energy system will be disassembled with the components appropriated for repurposing.

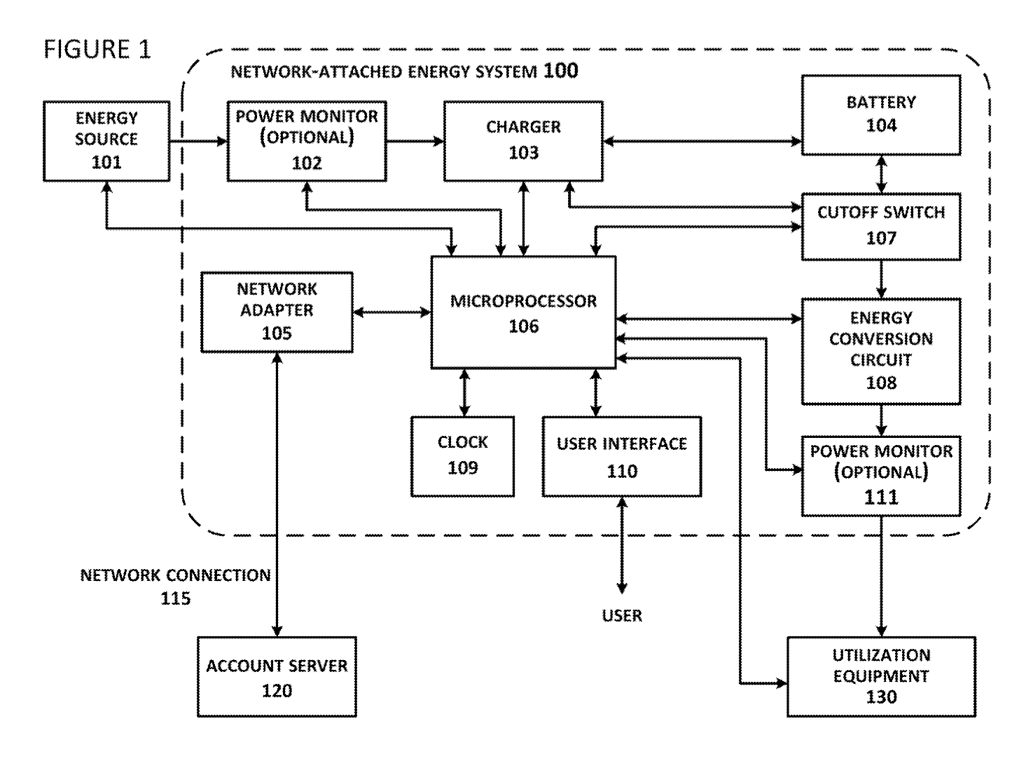

One embodiment of a network-attached energy system 100 (hereinafter “energy system”) is shown in FIG. 1. In one embodiment, energy system 100 comprises a charger 103, a battery 104, a network adapter 105, a microprocessor 106, a cutoff switch 107, an energy conversion circuit 108, a real-time clock 109, and a user interface 110. Energy system 100 is preferably a non-stationary, portable device, e.g., a system contained within a small, portable container the size of a satchel or briefcase, preferably with external access ports for connection to an energy source 101, a network connection 115 to account server 120, and/or utilization equipment 130.

Energy system 100 is coupled to the energy source 101 through charger 103. In various embodiments, energy source 101 can be a power cell, a battery, a generator, or a capture vehicle for a renewable energy source (e.g., a solar panel, a wind turbine or a hydropower source). Charger 103 receives and controls energy from energy source 101 and delivers electrical charge to battery 104. Battery 104 stores the electrical energy received from charger 103 for output on-demand to utilization equipment 130. Storage of electrical energy in battery 104 allows energy to be available to the user regardless of weather conditions (e.g., even if a day is cloudy).

Electrical energy from battery 104 to utilization equipment 130 is passed through energy conversion circuit 108 for voltage and/or current conversions (e.g., boosting or lowering the voltage) in order to provide required input ratings of utilization equipment 130. In one embodiment, energy conversion circuit 108 is a switch-mode direct current (DC) power converter.

One of skill in the art will recognize that, in other embodiments, energy system 100 need not have a charger 103 and battery 104. Instead, energy from energy source 101 is delivered directly to energy conversion circuit 108.

Any known power output connector (not shown) can be used to couple energy conversion circuit 108 to utilization equipment 130. In one embodiment, a plurality of energy conversion circuits 108 provide a plurality of output voltages and power output connections to accommodate a variety of utilization equipment 130. For example, energy system 100 can have a universal serial bus (USB) connector to allow charging of a cell phone or other device that uses a USB connector to charge. Or, energy system 100 can have a 12 V cigar lighter connector (as used to mate with a cigar lighter receptacle in an automobile) to power utilization equipment 130. In yet another example, energy conversion circuit 108 can be an inverter which provides an alternating power output such as 110 VAC typically found within a home.

Utilization equipment 130 is an electrical device, preferably a small device such as a mobile phone (e.g., a smartphone), a charging device (e.g., a cellphone charger) for a portable device, a computing device (e.g., a laptop or electronic tablet), a music device (e.g., a compact disc player), an appliance (e.g., a toaster or a television) or the like.

Microprocessor 106 is coupled to charger 103 and energy conversion circuit 108 to control energy storage and distribution from energy system 100. Specifically, microprocessor 106 is coupled to charger 103 to enable and disable charger 103 as well as to monitor and control a charge state of battery 104. Microprocessor 106 is coupled to energy conversion circuit 108 to control energy transfer from battery 104 to utilization equipment 130, as well as to monitor and/or control voltage and/or output current of energy conversion circuit 108.

Microprocessor 106 is also coupled to user interface 110, clock 109, and network adapter 105 to control user access to energy from energy system 100. A user interacts with energy system 100 through user interface 110. In one embodiment, user interface 110 comprises a keypad through which the user inputs data and/or commands to energy system 100 (e.g., to adjust system operating parameters such as date or time setting or to enter an activation code to access energy from energy system 100). In various embodiments, user interface 110 comprises a numeric keypad, an alphanumeric keyboard, a plurality of buttons, or the like and can be combined with a visual display (e.g., a panel with a liquid crystal display (LCD) or light-emitting diodes (LEDs)). In other embodiments, user interface 110 comprises a microphone through which the user can input an activation code or adjust system operating parameters.

In one embodiment, network adapter 105 is a wireless transceiver. Microprocessor 106 communicates through network adapter 105 to communicate across network connection 115 with account server 120 to authenticate a user's activation code and verify parameters of the user's access to energy from energy system 100 (as discussed further herein). In some embodiments (e.g., those using a time-based usage model as discussed elsewhere herein), when a user with a valid activation code is accessing energy from energy system 100, real-time clock 109 is used by microprocessor 106 to measure access time. Microprocessor 106 can retrieve the current time from account server 120 across network connection 115 and reset clock 109 to measure in real-time if necessary. In one embodiment, clock 109 includes a back-up power source such as a battery so that accurate time is maintained when battery 104 is depleted.

In one embodiment, network adapter 105 is a general packet radio service (GPRS) network modem which allows energy system 100 to transmit and receive data as internet protocol (IP) packets through a cellular network. Typical data transmitted and received include enable/disable signals, messages indicating battery state, messages indicating a state of energy system 100 (e.g., malfunction), and/or payment codes to allow/disallow user access to energy from energy system 100.

One of ordinary skill in the art will understand that network connection 115 can be, without limitation, a connection with/to an integrated services digital network (ISDN), a broadband ISDN (B-ISDN), a digital subscriber line (ADSL, ADSL+2), a symmetric digital subscriber line (SDSL), a very high speed DSL (VDSL), cable, cellular telephone, wireless, a broadband internet connection, a T-1 line, a bonded T-1 line, a T-3 line, an optical carrier level 3 (OC3), a satellite, or any other form of network connection now known or later developed. One of ordinary skill in the art will further understand that network connection 115 can be a combination of wired and/or wireless networks, a wide area network (WAN), a local area network (LAN), a global area network (GAN), a virtual private network (VPN), a personal area network (PAN), an enterprise private network, or any similar network now known or later developed.

In another embodiment, energy system 100 optionally comprises a power monitor 102 coupled to energy source 101, charger 103, and microprocessor 106 in order to monitor energy coming into energy system 100. In another embodiment, energy system 100 optionally comprises a power monitor 111 coupled to energy conversion circuit 108, utilization equipment 130, and microprocessor 106 in order to monitor energy going out of energy system 100. In yet another embodiment, microprocessor 106 communicates directly with energy source 101 and/or utilization equipment 130 rather than through power monitors 102 and 111 (respectively) in order to monitor energy entering and/or exiting energy system 100.

Prepaid Usage Models of Energy Transfer. Transfer of energy into or out of energy system 100 is controlled by prepaid usage models. Under a time-based usage model, a user acquires a usage balance based on a time period of usage (e.g., 5 hours of use), whereas under an energy-delivered usage model, the user acquires a usage balance based on energy delivered (to energy system 100 or to utilization equipment 130) rather than time (e.g., 100 Wh of energy delivered to energy system 100 or 100 Wh of energy delivered to utilization equipment 130). Regardless of the usage model, a user prepays for the usage balance (i.e., a predetermined quantity of use in terms of time or energy).

The user obtains the usage balance in the same way regardless of whether the usage balance is based on time or energy delivery. For example, in one embodiment, a user purchases a prepaid card with an activation code for a predetermined usage balance. The prepaid card is purchased from retailers, other users, distributors and/or any other participant in a distribution channel. In another embodiment, a user receives an activation code for a usage balance on a paper receipt as typically used for purchase of a commodity such as food. In yet another embodiment, the user uses a cellular telephone to contact and prepay account server 120 for a usage balance. In this case, an activation code can be conveyed to the user over the cellular telephone, or sent to the user via SMS messaging, email, or as a ringtone with an encoded activation code. In still another embodiment, account server 120 is accessed through interface 110 and an activation code is then purchased directly from account server 120 using, e.g., a credit card.

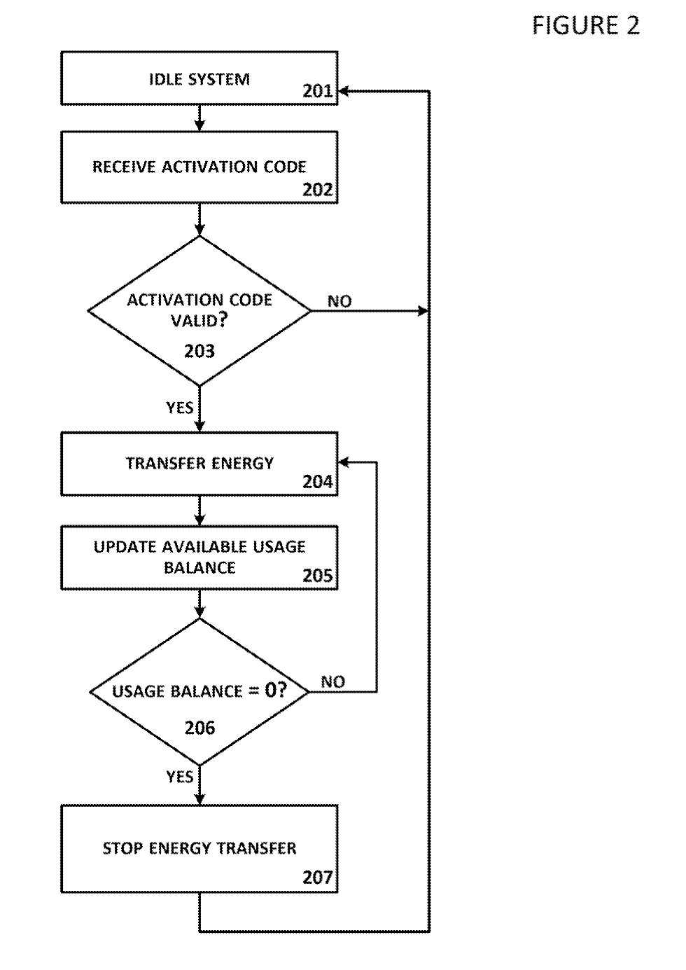

A flow chart of a method for controlled access to a tamper-resistant network-attached energy system according to one embodiment is presented in FIG. 2. In step 201, microprocessor 106 idles energy system 100 in a minimal-output state. In this minimal-output state, energy system 100 outputs minimal current (e.g., less than 1 mA) which allows energy system 100 to maintain its own baseline functions while not outputting energy to charge or run utilization equipment 130. Baseline functions include operation of system components (e.g., operation of clock 109 to maintain accurate real-time), operation of user interface 110 (e.g., to allow a user to communicate with account server 120 or to enter an activation code to utilize energy from the system), operation of charger 103 and battery 104 (e.g., to receive and store energy from energy source 101), and operation of network adapter 105 (e.g., to allow microprocessor 106 to communicate with account server 120).

In step 202, microprocessor 106 receives an activation code. In one embodiment, the activation code is input to energy system 100 via user interface 110. In other embodiments, the activation code is input to energy system 100 from account server 120 through network connection 115 (e.g., after user-input of credit card information through user interface 110 to prepay account server 120). In another embodiment, a ringtone with an encoded activation code (e.g., a ringtone obtained as a file from account server 120) is played in proximity to user interface 110, thereby conveying an encoded activation code to energy system 100.

In step 203, microprocessor 106 determines whether the activation code received in step 202 is valid. To make that determination, microprocessor 106 communicates through network adapter 105 across network connection 115 with account server 120. As part of this validation, account server 120 communicates an available usage balance associated with the activation code. The usage balance establishes usage credit available (e.g., in time units or in energy units) to transfer energy into energy system 100 or out of energy system 100. If account server 120 does not communicate that the activation code is valid, then microprocessor 106 does not transfer energy to energy system 101 and/or to utilization equipment 130 and energy system 101 returns to the minimal output state of step 201.

If, in step 203, microprocessor 106 determines that the activation code is valid, then, in step 204, microprocessor 106 directs the transfer of energy into or out of energy system 100. In one embodiment, microprocessor 106 communicates with energy conversion circuit 108 to output energy to utilization equipment 130. In another embodiment, microprocessor 106 communicates with energy source 101 to input energy into energy system 100.

In step 205, microprocessor 106 periodically updates the available usage balance as energy is transferred into or out of energy system 100. Energy can be transferred into or out of energy system 100 under a time-based usage model or an energy- delivered usage model.

Under the time-based usage model, the available usage balance is an amount of time (e.g., hours) available during which energy can be input to or output from energy system 100. In one embodiment of this model, upon activation of the activation code, microprocessor 106 determines a current time from clock 109 and stores the current time in memory as a start time. Microprocessor 106 also determines an end time (after which energy cannot be input to or output from energy system 100 on-demand) by adding the usage credit to the start time. As energy is input to, or output from, energy system 100, microprocessor 106 periodically retrieves a current time from clock 109 and compares the current time to the end time. Once the current time equals the end time, then microprocessor 106 no longer allows energy to be input to or output from energy system 100.

In other embodiments of the time-based usage model, as energy is transferred into or out of energy system 100, microprocessor 106 monitors clock 109 in real-time and periodically subtracts the time over which energy is being transferred from the usage balance to determine an updated available usage balance. Thus, in one embodiment, microprocessor 106 updates (e.g., reduces) the usage balance to reflect how long energy is output to utilization equipment 130. In another embodiment, microprocessor 106 updates (e.g., reduces) the usage balance to reflect how long energy is input to energy system 100.

In yet another embodiment of the time-based usage model, microprocessor 106 tracks the passage of time—regardless of whether or how much energy is input to or output from energy system 100—until the amount of time defined by the usage balance has expired. Once microprocessor 106 determines that amount of time has expired, then energy is no longer input to or output from energy system 100.

Under the energy-delivered usage model, the available usage balance is an amount of energy (e.g., KWh) that can be input to or output from energy system 100. Microprocessor 106 determines the updated usage balance by subtracting input or output energy from the usage balance to determine a remaining available usage balance. Thus, in one embodiment, microprocessor 106 updates (e.g., reduces) the user's usage balance to reflect energy output to utilization equipment 130. In another embodiment, microprocessor 106 updates (e.g., reduces) the usage balance to reflect energy input to energy system 100.

In step 206, microprocessor 106 determines whether the updated usage balance for energy access has been reduced to zero (i.e., no usage balance remaining). If the usage balance for energy access has not been reduced to zero, then microprocessor 106 returns to step 204 and continues to transfer energy into or out of energy system 100.

If, in step 206, microprocessor 106 determines that the updated usage balance for energy access has been reduced to zero, then, in step 207, microprocessor 106 stops the transfer of energy into or out of energy system 100, returns to step 201, and idles energy system 101 in the minimal output state.

Determination of whether the activation code is valid (step 203 of this process) need not occur each time the user wishes to transfer energy to or from energy system 100. For example, as energy is output from energy system 100 to utilization equipment 130, microprocessor 106 periodically updates (e.g., reduces) the usage balance accordingly and maintains a periodically updated available usage balance associated with the activation code. If the user has an available usage balance remaining from a previously validated activation code, microprocessor 106 need not communicate with account server 120 before transferring energy to energy system 100 and/or to utilization equipment 130. As another example, if the user inputs credit card information through user interface 110 to obtain an activation code, the activation code is transmitted from account server 120 directly to microprocessor 106, so microprocessor 106 need not communicate again with account server 120 to recognize the activation code as valid.

Anti-Tampering Features. The portability of energy system 100 increases the likelihood that energy system 100 will be disassembled and the components will be appropriated and repurposed. Thus, features that make energy system 100 resistant to tampering are desirable.

Referring again to FIG. 1, in some embodiments, microprocessor 106 controls energy input to and output from energy system 100 using a cutoff switch 107 coupled to energy source 101 (preferably through charger 103 and/or battery 104) and energy conversion circuit 108. In these embodiments, cutoff switch 107 allows energy flow between charger 103 and battery 104 (not shown) and/or between battery 104 and energy conversion circuit 108 when cutoff switch 107 is in a closed state. Thus, energy flows freely into and/or out of energy system 100 (presuming an authorized activation code has been entered) when the switch is in the closed state. When cutoff switch 107 is in an open state, minimal energy trickles between charger 103 and battery 104 and/or between battery 104 and energy conversion circuit 108. This minimal energy trickle allows energy system 100 to operate baseline functions (e.g., run clock 109), but energy does not flow freely into or out of energy system 100. Cutoff switch 107 can be implemented as a small microcontroller (not shown) with a metal oxide semiconductor field-effect transistor (MOSFET) as the switch (not shown). Communication between cutoff switch 107 and the microcontroller can be an inter-integrated circuit interface (I2C) or system-packet interface (SPI). The microcontroller can be the same as microprocessor 106 shown in FIG. 1 or a separate added processor.

In another embodiment, energy system 100 can be made tamper-resistant by encrypting communications between microprocessor 106 and cutoff switch 107 using known algorithms to make closing the switch inside cutoff 107 more difficult.

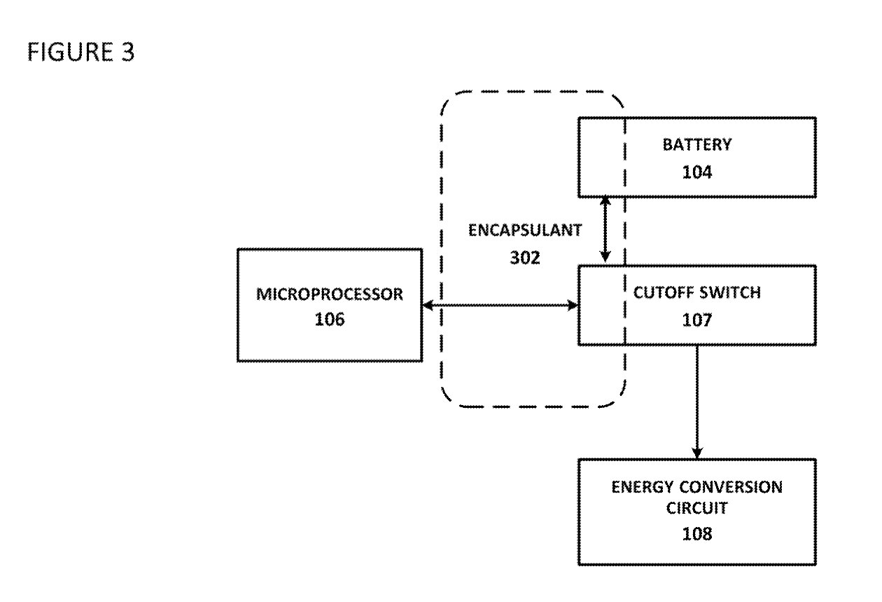

In yet another embodiment, an encapsulant can be used to protect key system components (e.g., battery 104 and connections thereto, cutoff 107 and connections thereto, connections to energy source 101, and/or connections to network adapter 105) from tampering. Physical encapsulation of key components makes disassembly of energy system 100 without damage difficult and is therefore another effective anti-tampering design feature. Referring now to FIG. 3, some key components of energy system 100 are shown in one embodiment of encapsulation. As shown in the figure, tampering is thwarted by encapsulating an end of cutoff switch 107, its connections to battery 104 and an end of battery 104, preferably completely, with an encapsulant 302. Such encapsulation provides anti-tampering protection regardless of whether cutoff switch 107 is located between charger 103 and battery 104 and/or between battery 104 and energy conversion circuit 108. In one embodiment, encapsulant 302 is an epoxy such as Resinlab EP1046FG from ResinLab (Germantown, Wis.), although one of skill in the art will understand that other encapsulants can be used.

In other embodiments, tampering can be thwarted with an electrical tamper sensor such as a chassis switch or other device used to sense tampering with or intrusion into energy system 100.

One of skill in the art will recognize that these anti-tampering features can be used in various embodiments singly or in a combined fashion. Thus, tampering can be deterred through use of cutoff switch 107, and/or encryption of communications between microprocessor 106 and cutoff 107, and/or encapsulation of key components, and/or use of an electrical tamper switch.

Microprocessor 106 communicates a signal to a signal line of cutoff switch 107 (i.e., closes the switch) so that energy flows into or out of energy system 100. If microprocessor 106 detects tampering within energy system 100 (e.g., by detecting a loss of connection between components of the system), microprocessor 106 interrupts communication of the signal to the signal line of cutoff 107 (i.e., opens the switch) and energy flow into or out of energy system 100 ceases.

In some embodiments, microprocessor 106 uses a global positioning satellite (GPS) sensor (not shown) to determine a location of energy system 100, which location is communicated through network adapter 105 across network connection 115 to account server 120. In one embodiment, the GPS sensor can be used to locate energy system 100 in the event of theft or change of location. Energy system 100 can sense and store its current location in memory of microprocessor 106. In other embodiments, current location can be sent by microprocessor 106 to account server 120 via network connection 115, thereby allowing account server 120 to monitor the location of energy system 100. When energy system 100 is moved to a new location, notification can be sent by account server 120 to interested parties (e.g., an owner of energy system 100).

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above.

Further, it should also be appreciated that the described method and apparatus can be implemented in numerous ways, including as a process, an apparatus, or a system. The methods described herein may be implemented by program instructions for instructing a processor to perform such methods, and such instructions recorded on a computer readable storage medium such as a hard disk drive, floppy disk, optical disc such as a compact disc (CD) or digital versatile disc (DVD), flash memory, etc., or a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A tamper-resistant, network-attached system comprising:
a battery;
a charger coupled to the battery, the charger configured to receive energy from an energy source and store the received energy in the battery;
a cutoff switch configured to receive the stored energy across an electrical connection between the cutoff switch and the battery, the cutoff switch further configured to output the received stored energy when a communication signal is received on a signal line of the cutoff switch;
an encapsulant material configured to encapsulate the electrical connection between the cutoff switch and the battery and at least a portion of the cutoff switch including the signal line of the cutoff switch;
an energy conversion circuit configured to receive the stored energy output from the cutoff switch and convert the received stored energy output from the cutoff switch into a form of energy useable by utilization equipment coupled to the system;
a network adapter configured to communicate across a network;
a user interface;
and
a microprocessor configured to:
provide the communication signal to the signal line of the cutoff switch;
receive through the user interface an activation code for a usage balance for the system;
determine that the received activation code for the usage balance is valid by communicating through the network adapter across the network with an account server;
command the energy conversion circuit to deliver the converted form of energy to the utilization equipment coupled to the system;
determine that the usage balance has been depleted; and
command the energy conversion circuit to no longer deliver the converted form of energy to the utilization equipment coupled to the system.

2. The system of claim 1 wherein the tamper-resistant network-attached energy system is a portable system.

3. The system of claim 1 wherein the activation code is prepaid.

4. The system of claim 1 wherein the energy source is a solar energy panel.

5. The system of claim 1 wherein the usage balance is a period of time.

6. The system of claim 1 wherein the usage balance is an amount of energy.

7. The system of claim 1 wherein the encapsulant is an epoxy.

8. The system of claim 1 wherein the user interface comprises a keypad or a microphone.

9. A tamper-resistant, network-attached system comprising:
a battery;
a charger coupled to the battery, the charger configured to receive energy from an energy source and store the received energy in the battery;
a cutoff switch configured to receive the stored energy across an electrical connection between the cutoff switch and the battery, the cutoff switch further configured to output the received stored energy when a communication signal is received on a signal line of the cutoff switch;
an encapsulant material configured to encapsulate the electrical connection between the cutoff switch and the battery and at least a portion of the cutoff switch including the signal line of the cutoff switch;
an energy conversion circuit configured to receive the stored energy output from the cutoff switch and convert the received stored energy output from the cutoff switch into a form of energy useable by utilization equipment coupled to the system;
a network adapter configured to communicate across a network;
a user interface;
and
a microprocessor configured to:
provide the communication signal to the signal line of the cutoff switch;
receive through the user interface an activation code for a usage balance for the system;
determine that the received activation code for the usage balance is valid by communicating through the network adapter across the network with an account server;
command the charger to deliver energy from the energy source to the battery;
determine that the usage balance has been depleted; and
command the charger to no longer deliver energy from the energy source to the battery.

10. The system of claim 9 wherein the tamper-resistant network-attached energy system is a portable system.

11. The system of claim 9 wherein the activation code is prepaid.

12. The system of claim 9 wherein the energy source is a solar energy panel.

13. The system of claim 9 wherein the usage balance is a period of time.

14. The system of claim 9 wherein the usage balance is an amount of energy.

15. The system of claim 9 wherein the encapsulant is an epoxy.

16. The system of claim 9 wherein the user interface comprises a keypad or a microphone.
